(19) United States
(12) Patent Application Publication
(10) Pub. No.: US 2004/0094418 A1
(43) Pub. Date: May 20, 2004

(54) Microchannel device

(76) Inventors: Timothy Ingram Cox, Worcestershire (GB); Mark Christopher Tracey, Hatfield Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/467,839

(22) PCT Filed: Feb. 11, 2002
(86) PCT No.: PCT/GB02/00545

(30) Foreign Application Priority Data
Feb. 13, 2001 (GB) 0103441.2

(51) Int. Cl. G01N 27/27; G01N 27/403

(52) U.S. Cl. 204/450; 204/451; 204/601

(57) ABSTRACT

This invention relates to a microchannel device comprising a microchannel and a liquid introduction means for introducing at least two liquids into the microchannel; characterised in that the introduction means comprises a pulse means for introducing each liquid into the microchannel in the form of a plurality of pulses, and for staggering the pulses of each liquid relative to the pulses of the other liquids. The device may be used to mix liquids for microfluidic applications.

This invention relates to a new microchannel device. More particularly this invention relates to a new microchannel device that facilitates the mixing of two or more liquids in a microchannel. This invention also relates to anew method of mixing together two or more liquids in a microchannel.

A microchannel device is one that has one of more microchannels along which a liquid may flow, the microchannel or each microchannel having a dimension, perpendicular to the channel, between 100 nm and 1 mm. In addition to a microchannel the device may comprise other components such as: a chamber, a filter, an electrode, a pump, a valve, or a mixing system. Microchannels may be formed from PTFE, plastic, glass, quartz, or by michromachining a silicon wafer.

Microchannel devices are used for analytical and synthetic applications that involve very small quantities of substance. For example the reagents used for an analytical process may be expensive; by performing the process in a microchannel device the quantities of chemical required are small and hence the cost is minimised.

The combination of some chemicals, because of their highly reactive nature, may only be possible at a small scale.

Because microchannel devices may be mass produced at relatively low cost, a reaction can be scaled up simply by performing the reaction simultaneously in the required number of microchannel devices.

Performing reactions and other processes at such a small scale can, however, present some significant problems. A particular area of concern is the combination of two or more liquids, necessary as the first step in bringing about a chemical reaction. Because of laminar flow, it is usually insufficient simply to flow the two liquid together; the adjacent flow only resulting in the liquids remaining largely unmixed. This laminar flow results from the small dimensions of the channels and the flow velocities conventionally used in microfluidics. Such mixing that does occur results from diffusion across the interface between the two liquids.

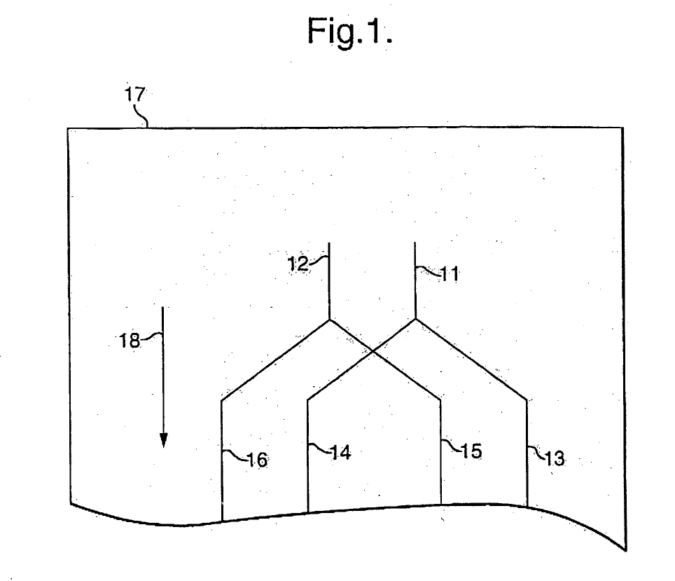

One way in which this problem may be addressed is by dividing the flow of each liquid to be mixed into multiple streams; each stream having a reduced cross-sectional area, as shown in FIG. 1. FIG. 1 is a schematic diagram of part of a prior art device by which multiple streams may be generated. A plurality of microchannels 11, 12, 13, 14, 15, and 16 are fabricated on a silicon chip 17. The microchannels 11 to 16 comprise a first microchannel 11, a second microchannel 12, a third microchannel 13, a fourth microchannel 14, a fifth microchannel 15, and a sixth microchannel 16. The first microchannel 11 contains a firstliquid, and the second microchannel 12 contains a second liquid. The arrow 18 shows the direction in which both liquids flow. The first microchannel 11 flows into the third 13 and a fourth 14 microchannel both of reduced dimension perpendicular to the flow. The second microchannel 12 flows into a fifth 15 and sixth 16 microchannel also both of reduced cross-sectional dimension perpendicular to the flow. The fourth 14 and fifth 15 microchannels are fabricated in such a manner that they cross but do not intersect.

As a result of crossing of the fourth 14 and fifth 15 microchannels a spatially alternating order of liquids is obtained. The order of the liquids at the bottom of FIG. 1, from right to left, is: first liquid, second liquid, first liquid, and second liquid. The four streams contained in the third 13, fourth 14, fifth 15, and sixth 16 microchannels may be combined into a single microchannel (not shown in FIG. 1) in such a manner that the alternating order and reduced cross-sectional area is retained. In this way interaction and therefore mixing by diffusion is enhanced.

The FIG. 1 apparatus represents a less than ideal solution since it is relatively complex and difficult to fabricate. In particular, it is difficult to micromachine channels that cross but do into intersect. A further problem with the FIG. 1 apparatus is that it is difficult to alter the ratio of the first and second liquids in the resulting mixture, the ratio being largely decided by the relative cross-sectional areas of the microchannels.

A second way in which two liquids flowing in a microchannel may be combined is by simply increasing the flow rate through the microchannels until the Reynolds numbers are greater than approximately 2300. For such high Reynolds numbers there is turbulent flow and consequent mixing of the liquids. For pressure driven flow, in order to obtain sufficiently high flow rates for Reynolds numbers greater than 2300, pressures in excess of 1 million Pa may be required. This will necessitate the use of relatively robust microchannel devices, which in practice may be difficult to fabricate.

The following prior art is considered to be relevant to the present invention GB 2355414 A describes a micro-mixer having opposed nozzles. DE 196 11 270 A1 describes a micro-mixer for very small volumes of liquid U.S. Pat. No. 6,150,110 describes the serial introduction of multiple different samples into a microfluidic channel network.

Further relevant prior art was presented, by A. Deshmukh, at the Solid State Sensors and Actuator Workshop, Jun. 4-8, 2000, Crowne Plaza Resort, Hilton Head, S.C., USA.

It is an object of the present invention to provide a new microchannel device, and a new method of mixing two or more liquids in a microchannel, That reduces the above mentioned problems.

According to a first aspect, the invention provides a method of mixing at least two liquids in a microchannel, comprising the steps: (a) introducing each liquid into the microchannel, and (b) flowing each liquid along the microchannel; wherein the step (a) comprises the steps of (i) introducing each liquid into the microchannel in the form of a plurality of pulses, and (ii) staggering said plurality of pulses, of each liquid, relative to those of the other liquid or liquids; characterised in that each liquid is introduced into the microchannel through at least one inlet channel having an inlet opening in the wall of the micro channel the depth of which inlet channel at the point of entry into the microchannel is less than the depth of the microchannel.

For the absence of doubt, the term “liquid” should be taken to include solutions and suspensions.

The pulses may be formed by repeatedly increasing and decreasing the rate at which each liquid is introduced into the microchannel. The pulses may be formed by repeatedly stopping and starting the flow of each liquid into the microchannel. For example the pulses may be formed by repeatedly opening and closing a valve. Alternatively the pulses may be formed by modulation of the introduction of each liquid by means of a controllable pump. The formation of a pulse need not involve the complete cessation of liquid flow into the microchannel for any of the components to be mixed.

Staggering may be achieved by sequentially opening and closing a plurality of valves. By staggering the pules, different liquids may be introduced at different times. For example only one of the liquids may be introduced at a given time, by ensuring that one valve is open while the other valve or valves are closed.

Staggering the pules causes the liquids to mix more efficiently in the microchannel. The efficiency of the technique means that the utilisation of high pressures and complex structures is not required. The reason for this improvement in mixing is due to some degree of spatial separation between the different liquids along the length of the microchannel and normal to it. A further factor is the non-uniform flow profile across the width of the microchannel, the flow being fastest at the centre of the microchannel. The combination of these two factors results in an increased interfacial area between adjacent pulses as they proceed along the channel, and to a reduced mean diffusion path required for mixing between the pulses by virtue of their thinning as the interfacial area increases.

By contrast, prior at methods often tend to result in spatial separation of the different liquids across the width of the microchannel. For this case, the non-uniform flow profile will not promote mixing.

For the present invention it may be that the spatial separation along the length, as opposed to the width, of the microchannel allows flow along the microchannel to cause mixing of the different liquids. It should be noted that any spatial separation between the components, along the length of the microchannel, is likely to be most pronounced in the region of the microchannel at which the liquids are introduced, such spatial separation tending to diminish as the liquids pass along the microchannel due to the non-uniform flow across the microchannel.

Each pulse may be introduced into the microchannel in such a manner that it is in contact with opposite sides of the microchannel.

The duration between any one of the valves being open and being closed may be less than 5 seconds. The duration between any one of the valves being closed and being open may be less than 0.1 seconds. A delay may be introduced between the opening of one valve and the closing of another, such a delay may be less than 0.1 seconds.

Each liquid may be introduced into the microchannel at substantially the same position in the microchannel as the other liquids.

Preferably each of the liquids may be introduced into a portion of the microchannel, of width w, the portion having a length of less than 5w, measured along the direction of flow of the liquids in the microchannel. More preferably ach of the liquids may be introduced into a portion of the microchannel, the portion having a length of less than 2w.

Advantageously step (a) is performed in such a manner that the flow of each of the liquids, open entry into the microchannel, is substantially perpendicular to the length of the microchannel.

The microchannel may be attached to or formed in a substrate. For the purposes of this specification the term “depth of the microchannel” shall be defined as the cross-sectional dimension of the microchannel that is substantially perpendicular to the plane of the substrate, and the term “depth of the inlet channel” shall be defined as the cross-sectional dimension of the inlet channel, at the point of entry of the inlet channel into the microchannel, that is substantially perpendicular to the plane of the substrate.

The depth of the or at least one of the inlet channels may be less than one half of the depth of the microchannel.

The depth of the or at least one of the inlet channels may be less than one tenth of the depth of the microchannel.

The cross-sectional area of the or at least one of the inlet channels may be less than the cross-sectional area of the microchannel.

The cross-sectional area of the or at least one of the inlet channels may be less than half of the cross-sectional area of the microchannel.

The cross-sectional area of the or at least one of the inlet channels may be less than one tenth of the cross-sectional area of the microchannel.

Preferably the volume of the microchannel is less than 20 μl. More preferably the volume of the microchannel is less than 5 μl.

Advantageously step (a) is performed in such a manner that at least one of the pulses of one liquid contacts the pulse of another liquid as it enters the microchannel.

The location, pressure, and time at which each liquid is introduced may be such that vortices are established in the microchannel as a result of interaction between the or at least two of the liquids.

The formation of vortices by the introduction of liquids into the microchannel may assist in mixing the liquid together.

The microchannel may have at least one cross-sectional dimension less than 100 μm. The microchannel may have a cross-sectional area less than 10,000 μm².

The introduction of the or at least two of the liquids into the microchannel may be performed in such a manner that the flow of liquid at the end of the microchannel, remote from the region in which the liquids are introduced, is substantially continuous for a period greater than 100 seconds.

Many synthetic and analytical techniques require a relatively constant flow of reactant or product, a criterion that may be met by this invention. For example continuous operation of valves introducing the liquids allows continuous output from the microchannel.

The composition of the resulting mixture may be altered by altering the relative duration of the pulses. For example if a first liquid is to be mixed with a second liquid, then the proportion of the first liquid can be increased by increasing the pulse length of the first liquid relative to that of the second.

Again this is a significant feature with regard to many synthetic and analytical applications, which require variation in the proportion of a reaction for a give mixture.

In the case in which to liquids are to be mixed, high ratios, for example 10:1, 100:1, and 1000:1, of mixing may be achieved

Preferably the formation and staggering of the pulses is performed in such a manner that only one liquid is introduced into the microchannel at any given time. More preferably the formation and staggering of the pulses is performed in such a manner that the liquid being introduced into the microchannel is repeatedly altered.

Advantageously the method comprises the further step of using an electronic component to control the duration of each pulse. More preferably the electronic component comprises a computer.

Advantageously the dimensions of the microchannel and the rate at which the liquids are introduced into the microchannel is such that the flow of liquid through the microchannel is non-uniform across the width of the microchannel. More advantageously the flow of liquid through the microchannel is substantially parabolic. In other words the velocity distribution, across at least one line of cross-section, is substantially parabolic. It is believed that this parabolic flow results in greater interaction between the different components to be mixed, enhancing the area of interaction, reducing spatial separation, and therefore the distance required for diffusion to effect mixing as the pulses flow along the microchannel.

Preferably the flow of each of the liquids through the microchannel is caused only by introduction of each of the liquids into the microchannel. In other words the flow of each of the liquids through the microchannel is not caused by introduction of gas into the microchannel. Gas may be used to apply pressure to the liquids to be mixed, provided contact between the gas and the liquid does not occur within the microchannel. Alternatively, flow may be induced by a microfluidic pump or by an elecrokinetic phenomenon.

Step (b) may comprise the step of electrokinetically pumping at least some of the liquids in the microchannel. Step (b) may comprise the step of electrokinetically pumping at least some of the liquids in the microchannel in such a manner that parabolic flow is induced.

The flow of each of the liquids through the microchannel without the use of gas in the microchannel minimises the risk of contamination, either by dissolution of the gas in the liquid, or bubble formation.

Advantageously step (a) comprises the step of introducing each liquid into the microchannel by means of an electrokinetic pump.

Preferably step (a) is performed in such a manner that each pulse contacts part of the microchannel wall substantially opposite the inlet channel through which it was introduced.

By performing step (a) in this manner, it is possible to form a pulse that is in contact with the region of the inlet channel and in contact with the region of the microchannel wall opposite to the inlet channel. The flow along the channel of a pulse at the opposite points of contact will be inhibited relative to the flow along the channel at the points along the line joining the opposite points of contact. It is believed that the difference in flow rates between the middle of a pulse and the edges of a pulse benefits the mixing process.

Step (a) may comprise the step of causing each pulse to contact two points in said microchannel in such a manner that a line between said contact points is substantially perpendicular to the direction of liquid flow through the microchannel.

Advantageously each pulse is introduced through at least two inlet channels. More advantageously the two or two of the inlet channels, through which each pulse is introduced, are located substantially opposite each other.

The liquid from the two or more inlet channels flow together in the microchannel to form each pulse. The formation of each pulse by the flow of liquid through two or more inlet channels allows each pulse to contact the microchannel at points, in the region of the inlets through which the pulse was introduced that are spaced from one another. Flow of each pulse is inhibited at the points of contact, assisting the mixing process.

Step (b) may comprise the step of applying gas pressure to the liquid in the microchannel by means of a hydrophobic membrane.

According to a second aspect the invention provides a microchannel device comprising a microchannel and liquid introduction means for introducing at least two liquids into the microchannel through at least one inlet channel having an inlet opening in the wall of the microchannel; the liquid introduction means comprising pulse means for introducing each liquid into the microchannel in the form of a plurality of pulses, and for staggering the pulses of each liquid relative to the pulses of the other liquid(s); characterised in that the depth of the or each said inlet channel at the point of entry into the microchannel is less than the depth of the microchannel.

The or each said inlet channel may be substantially perpendicular to the microchannel.

The liquid introduction means may comprise a valve, associated with one of the liquids; the valve, microchannel, and liquid being arranged such that opening and then closing the valve causes a pulse of liquid to be released into the microchannel.

Preferably the liquid introduction means comprises a plurality of valves. More preferably the control means comprises a means for sequentially opening and closing each of said plurality of valves. Yet more preferably the control means comprises a means of opening only one valve at any given time and for ensuring that the other valve or valves are closed. Even more preferably the control means comprises a means for repeatedly altering which of said plurality of valves is open at any given time.

The control means may comprise a means for forming said plurality of pulses by repeatedly stopping and starting the flow of liquid into the microchannel.

The liquid introduction means may comprise an electrokinetic pump, associated with one of the liquids, the electrokinetic pump, microchannel, and liquid being arranged such that the activation of the electrokinetic pump causes a pulse of liquid to be released into the microchannel. The electrokinetic pump may be arranged and activated in such a manner that a non uniform velocity profile is generated across the microchannel. The electrokinetic pump may be arranged and activated in such a manner that a parabolic velocity profile is generated across the microchannel.

Preferably the liquid introduction means comprises a plurality of electrokinetic pumps. More preferably the control means comprises a means for sequentially activating and deactivating each of said electrokinetic pumps. Yet more preferably the control means comprises a means of activating only one electrokinetic pump at any given time and for ensuring that the other electrokinetic pump or pumps are inactive. Even more preferably the control means comprises a means for repeatedly altering which of said plurality of electrokinetic pumps is activated at any given time.

The means for introducing each liquid into the microchannel in the form of a plurality of pulses may have a construction such that each pulse is in contact with opposite sides of the microchannel.

Each valve may be connected, by means of an inlet channel, to the microchannel.

Preferably the or each said inlet opening my be formed within a portion of the microchannel having a length less than 10 mm. More preferably the or each said inlet opening may be formed within a portion of the microchannel having a length less than 5 mm.

Advantageously the pulse means is constructed in such a manner that the flow of each of the liquids into the microchannel is substantially perpendicular to the length of the microchannel.

The depth of the or each inlet channel at the point of entry into the microchannel may be less than half of the depth of the microchannel.

The depth of the or each inlet channel at the point of entry into the microchannl may be less than one tenth of the depth of the microchannel.

The cross-sectional area of the or each inlet channel may be less than the cross-sectional area of the microchannel.

The cross-sectional area of the or each inlet channel may be less than one half of the cross-sectional area of the microchannel.

The cross-sectional area of the or each inlet channel may be less than one tenth of the cross-sectional area of the microchannel.

At least part of the liquid associated with each valve my be contained in a reservoir in such a manner that liquid may flow from the reservoir into the valve.

Preferably the microchannel has a smallest cross-sectional dimension between 500 μm and 100 nm. More preferably the microchannel has a smallest cross-sectional dimension between 100 μm and 1 μm.

The microchannel may comprise at lest two sub-channels, each sub-channel being substantially parallel to the microchannel, the cross-sectional area of each sub-channel being less than that of the microchannel, and each sub-channel being located within the microchannel.

Provided that each sub-channel is sufficiently long parabolic flow may be established in each sub-channel. The establishment of parabolic flow in each sub-channel assists the mixing process.

Advantageously the control means comprises a means for allowing only one of the liquid to be introduced into the microchannel at any given time. More advantageously the control means comprises a means for repeatedly altering which of the liquids is to be introduced into the microchannel.

Preferably control means comprises an electronic component. More advantageously the control means comprises a computer. Yet more advantageously the control means comprises a computer that has been programmed to operate in real time.

The liquid introduction means may have a construction such that each pulse is introduced through one inlet channel, and such that each pulse contacts part of the microchannel wall substantially opposite the inlet channel through which it was introduced.

The liquid introduction means may have a construction such that each pulse is introduced through at least two inlet channels. More preferably the liquid introduction means has a construction such that each pulse is introduced into two inlet channels disposed on opposite sides of the microchannel.

Advantageously the microchannel is substantially closed at one end. More advantageously the microchannel is closed at the end of the microchannel that is substantially adjacent to at the or at least one of the inlet channels.

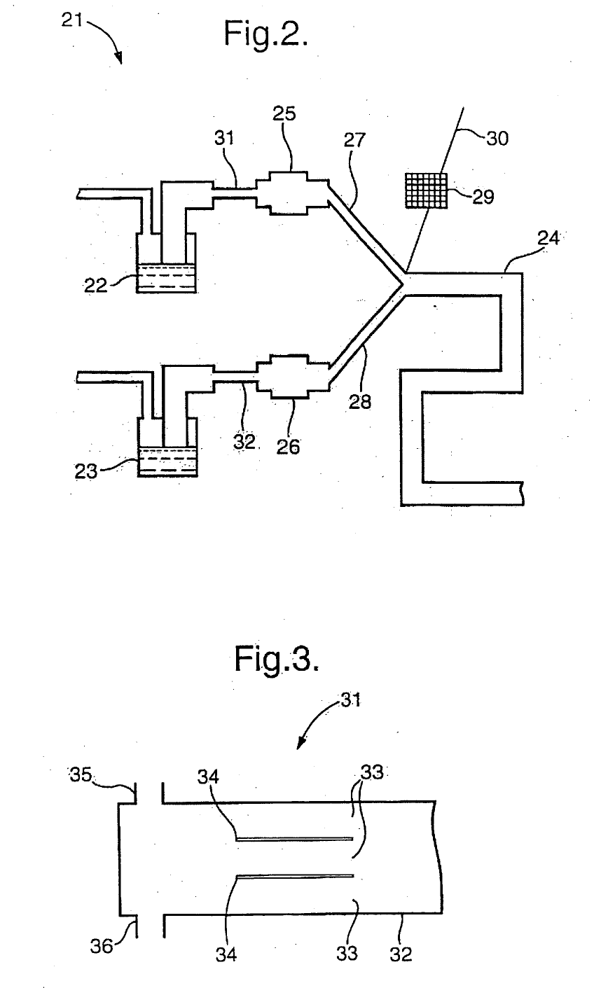

The invention will now be described, by way of example only, with reference to FIGS. 2 and 3. The figures are:

FIG. 1 which shows a schematic diagram of part of a prior art microchannel device;

FIG. 2, which shows a schematic diagram of a microchannel device according to the invention;

FIG. 3, which shows a schematic diagram of a microchannel device, according to the invention, comprising at least two sub-channels;

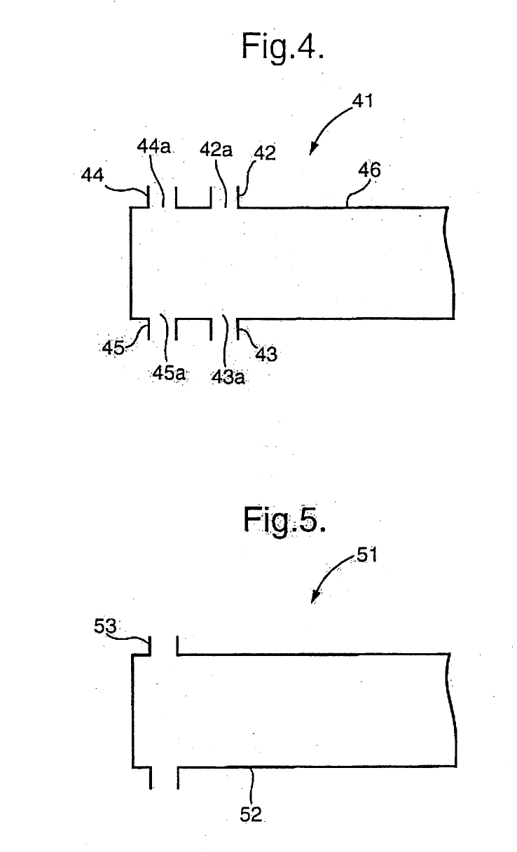

FIG. 4, which shows a schematic diagram of a microchannel device, according to the invention, in which each pulse of liquid is introduced through two inlet channels;

FIG. 5 shows a schematic diagram of microchannel device according to the invention, in which each inlet channel is perpendicular to the microchannel;

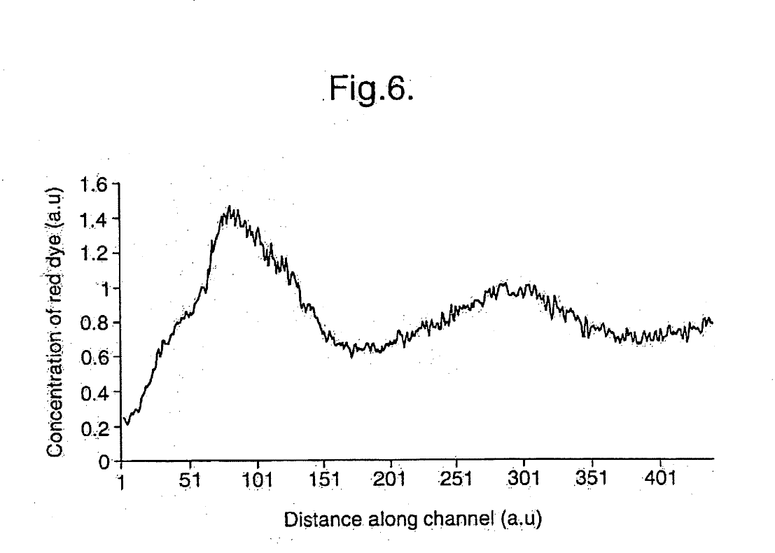

FIG. 6 shows the absorption of light by a microchannel device, according to the invention, containing two liquids, as a function of the distance along the microchannel; and

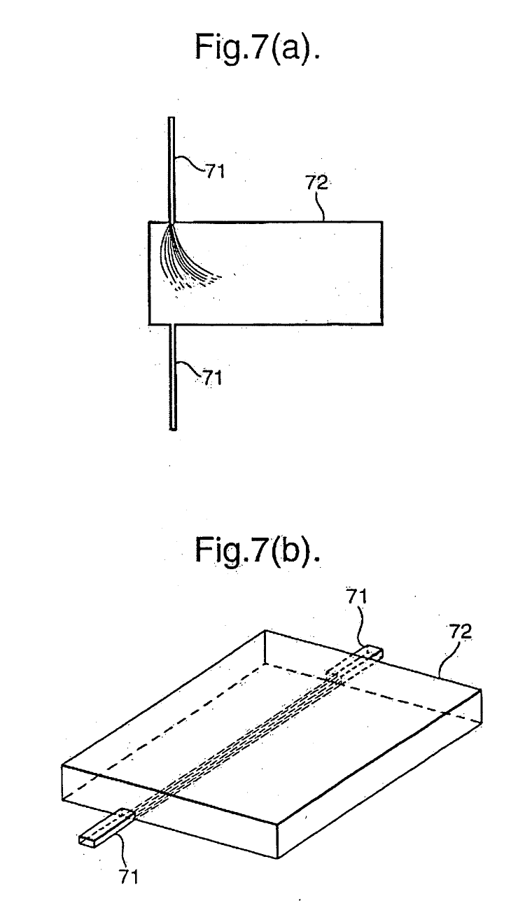

FIG. 7 shows modelling results relating to injeciton of pulses into a microchannel by a method according to the present invention.

FIG. 2 shows a schematic digram of a microchannel device according to the invention generally indicated by 21. First and second reservoirs 22, 23 are connected to a microchannel 24 via first and second valves 25, 26 and flow restrictors 27, 28, 31 and 32. The first reservoir 22 contains a first liquid and the second reservoir 23 contains a second liquid. For the purposes of this example the first liquid will be taken to be an aqueous solution of a first water soluble dye, and the second liquid will be taken to be an aqueous solution of a second water soluble dye.

The mixing microchannel 24 has cross sectional dimensions 1 mm×100 microns. In other words the microchannel 24 has a width of 1 mm and a depth of 100 microns. The total length of the microchannel 24 is 19 cm and it is arranged in a serpentine structure to conserve space. The microchannel 24 is fabricated by bonding together two laminae of polymethyl methacrylate (PMMA) by applying pressure at 120° C. The microchannel structures are formed in one of the PMMA layers by micromilling. Connection conduits are formed through the other PMMA layer to allow connection to the buried microchannel structure. Metal tubes are glued into the connection conduits to allow easy connection of plastic tubing.

A pressure of 40 KPa is applied to the first and second liquid by means of compressed air. The input of the first and second liquids into the microchannel 24 is controlled by two valves 25 and 26. Gas pressure is therefore used to introduce the first and second liquids into the microchannel 24, but does not itself enter the microchannel 24.

The first and second valves 25, 26 are connected to a control means (not shown in FIG. 2) that controls whether the first and second valves 25, 26 are open or closed. The control means may be programmed so that only one of the first and second valves 25, 26 is open at any given time. The control means may also alternate which of the two valves 25, 26 is open so that alternating pulses of the first and second solutions are released into the microchannel 24. In this way the introduction of the first and second liquid is staggered so that the first liquid is not introduced at the same time as the second liquid.

The duration of each pulse, for either the first or the second liquids, is approximately 0.8 seconds, 1.2 pulses are released into the microchannel 24 per second. By staggering the pulses, some degree of spatial separation, between the first and second liquids, occurs along the length of the microchannel 24. This spatial separation is greatest in the region of the microchannel 24 at which the two liquids are introduced. As the two liquids move along the microchannel 24 they become mixed.

Valves 25 and 26 are commercially available solenoid valves. Each valve 25 and 26 displaces liquid when it closes, exerting a pumping action. The pumping action can be minimised by locating flow restrictors 27, 28, 31, and 32 on both sides of each valve. Each flow restrictor has a length of 5 mm, a depth of 40 microns and width of 100 microns.

By having flow restrictors 27, 28, 31, and 32 placed on both sides of each valve, the effect of liquid flow in the microchannel of the closing action of the first and second valves 25, 26 is minimised. The closure of the first and second valves 25, 26 tends to cause an increase in pressure in the region of the valves 25, 26. The arrangement of the flow restrictors results in the microchannel being shielded from the pumping effect of the solenoid valves 25, 26.

In the FIG. 2 embodiment of the invention, the flow restrictors 27 and 28 form the inlet channels by which the first and second liquids are introduced into the microchannel. In other words the dimensions of the inlet channels, for the FIG. 2 embodiment are: 40 microns (depth), 100 microns (width), and 5 mm (length).

After a mixture of the first and second liquids has been delivered to the microchannel 24, the liquid contained in the microchannel 24 may be delivered by application of gas pressure to the liquid. Pressure is applied via a gas line 30, conveniently at a pressure of 10 kPA, which is connected via a hydrophobic membrane 29 which allows passage of gas but not aqueous based liquids. Thus when liquid was delivered to the microchannel 24 via valves 25 and 26, flow is stopped by the hydrophobic membrane 29. The delivery of the liquid along the microchannel 24 in this way also causes a mixing action.

In a further embodiment, not shown in the figures, a microchannel device according to the invention may have an identical construction to that of the FIG. 2 device, save that it has a microchannel depth of 200 microns.

FIG. 3 shows a microchannel device, generally indicated by 31, comprising a microchannel 32 and inlet channels 35, 36. The microchannel comprises three sub-channels 33, formed by baffles 34. Liquids flow down the length of the microchannel 31 and undergo mixing. If the sub channels are sufficiently long then parabolic flow of the liquid through the sub-channel may occur. The presence of the baffles 34 therefore increases the mixing interaction between the liquids, relative to that which would have occurred in the absence of the baffles 34.

FIG. 4 shows a microchannel device, generally indicated by 41, having first inlet channels 42, 43, and second inlet channels 44, 45. The inlet channels 42, 43, 44, and 45 form inlet openings 42a, 43a, 44a, and 45a in the wall of the microchannel 46. A first liquid is introduced through the first inlet channels 42 and 43, and a second liquid is introduced through the second inlet channels 44 and 45. The first and second liquids are introduced in the form of a plurality of pulses. Each pulse of the first liquid is formed by the substantially simultaneous flow of liquid through both the first inlet channels 42, 43. Each pulse of the second liquid is formed by the substantially simultaneous flow of liquid through both the second inlet channels 44, 45. The two first inlet channels 42, 43 are arranged on opposite sides of the microchannel, and the two second inlet channels 44 45 are also arranged on opposite sides of the microchannel to each other. This arrangement of the inlet channels 42, 43, 44, and 45 causes greater interaction of the two liquids as they flow along the microchannel. FIG. 5 shows a schematic diagram of a further microchannel device, generally indicated by 51, according to the invention. The microchannel device is identical to that shown in FIG. 3, save that it does not comprise sub channels. The cross sectional dimensions of the microchannel 52 are 1 mm (width) by 200 microns (depth). The inlet channels 53 have cross sectional dimensions 100 microns (width) by 40 microns (depth). The inlet channels 53 are arranged so that they are perpendicular to the microchannel 52 and the end of the microchannel 52 adjacent to the inlet channel 53 is closed. The walls of the FIG. 5 microchannel 52 are constructed from a transparent material.

FIG. 6 shows the results of an experiment conducted using the FIG. 5 apparatus. Pulses of water and an aqueous solution of red dye are introduced into the FIG. 5 microchannel by a method according to the invention. The FIG. 6 plot shows the concentration, in the centre or the channel, of red dye in the microchannel versus distance along the microchannel. The concentration of the red dye in the microchannel is determined by measuring the absorption of light by the liquid in the channel. The concentration being determined by the Veer Lambertlaw. FIG. 6 illustrates the mixing effectiveness of the methods and devices of the invention.

CFD (Flume CAD (RTM) (Conventor) was used to investigate mixing of two liquids by a method according to the invention. The results of a 2D calculation are shown in FIG. 7(a). FIG. 7(a) shows the injection of a pulse through one of the inlet channels 71. As can be seen from the FIG. 7(a) results, the pulse does not reach the opposite wall of the microchannel 72.

FIG. 7(b) shows the results for the same microchannel device, as for FIG. 7(a). However, the FIG. 7(b) calculation was performed for a 3D simulation. The reason for the difference between the FIGS. 7(a) and 7(b) results is that the FIG. 7(b) calculation takes account of the difference of the depths of the inlet channel 71 and microchannel 72. Because the FIG. 7(a) results are for a 2D calculation, the depth of the injection channel is treated as being effectively the same as the depth of the microchannel for these results. The FIG. 7 results therefore show that it is advantageous that the depth of each of the inlet channels should be less than the depth of the microchannel.

1. A method of mixing at least two liquids in a microchannel, comprising the steps: (a) introducing each liquid into the microchannel (24,32,46,52,72), and (b) flowing each liquid along the microchannel (24,32,46,52,72); wherein the step (a) comprises the steps of (i) introducing each liquid into the microchannel (24,32,46,52,72) in the form of a plurality of pulses, and (ii) staggering said plurality of pulses, of each liquid, relative to those of the other liquid or liquids; characterised in that each liquid is introduced into the microchannel (24,32,46,52,72) through at least one inlet channel (27,28,35,36,42,43,44,45,53,71) having an inlet opening in the wall of the microchannel (24,32,46,52,72) the depth of which inlet channel (27,28,35,36,42,43,44,45,53,71) at the point of entry into the microchannel (24,32,46,52,72) is less than the depth of the microchannel (24,32,46,52,72).

2. A method according to claim 1 wherein step (a) is performed in such manner that each pulse contacts part of the microchannel wall substantially opposite the inlet channel (27,28,35,36,42,43,44,45,53,71) through which it was introduced.

3. A method according to claim 1 or claim 2 wherein step (a) is performed in such a manner that each liquid is introduced into the microchannel (24,32,52,72) at substantially the same position in the microchannel (24,32,52,72) as the other liquids.

4. A method according to any preceding claim wherein the location, pressure, and time at which each liquid is introduced is such that vortices are established in the microchannel (24,32,46,52,72) as a result of interaction between the or at least two of the liquids.

5. A method according to any preceding claim wherein step (a) is performed in such a manner that the flow of liquid at the end of the microchannel (24,32,46,52,72), remote from the region in which the liquids are introduced, is substantially continuous for a period greater than 100 seconds.

6. A method according to any preceding claim wherein the rate at which the liquids are introduced into the microchannel (24,32,46,52,72) is so chosen in relation to the dimensions of the microchannel (24,32,46,52,72) that the flow of liquid through the microchannel (24,32,46,52,72) is substantially parabolic.

7. A microchannel device comprising a microchannel (24,32,46,52,72) and liquid introduction means (22,23,25,26) for introducing at least two liquids into the microchannel (24,32,46,52,72) through at least one inlet channel (27,28,35,36,42,43,44,45,53,71) having an inlet opening in the wall of the microchannel (24,32,46,52,72); the liquid introduction means (22,23,25,26) comprising pulse means for introducing each liquid into the microchannel (24,32,46,52,72) in the form of a plurality of pulses, and for staggering the pulses of each liquid relative to the pulses of the other liquid or liquids; characterised in that the depth of the or each said inlet channel 927,28,35,36,42,43,44,45,53,71) at the point of entry into the microchannel (24,32,46,52,72) is less than the depth of the microchannel (24,32,46,52,72).

8. A microchannel device according to claim 7 wherein the or each said inlet channel (35,36,42,43,44,45,53,71) is substantially perpendicular to the microchannel (32,46,52,72).

9. A microchannel device according to claim 7 or claim 8 wherein the liquid introduction means comprises a valve (25,26), associated with one of the liquids; the valve (25,26), microchannel (24,32,46,52,72), and liquid being arranged such that opening and then closing the valve (25,26) causes a pulse of liquid to be released into the microchannel (24,32,46,52,72).

10. A microchannel device according to claim 9 wherein the liquid introduction means comprises a plurality of valves (25,26).

11. A microchannel device according to any one of claims 7 to 10 wherein the or each said inlet opening is formed within a portion of the microchannel (24,32,46,52,72) having a length less than 10 mm.

12. A microchannel device according to any one of claims 7 to 11 wherein the microchannel (24,32,46,52,72) has a smallest cross-sectional dimension between 1 mm and 100 nm.

13. A microchannel device according to any one of claims 7 to 12 wherein the depth of the or each inlet channel (27,28,35,36,42,43,44,45,53,71) at the point of entry into the microchannel (24,32,46,52,72) is less than half of the depth of the microchannel (24,32,46,52,72).

14. A microchannel device according to nay one of claims 7 to 12 wherein the microchannel (32) comprises at least two sub-channels (33), each sub-channel (33) being substantially parallel to the microchannel (32), the cross-sectional area of each sub-channel (33) being less than that of the microchannel (32), and each sub-channel (33) being located within the microchannel (32).
